(19) United States
(12) Patent Application Publication
(10) Pub. No.: US 2013/0204654 A1
(43) Pub. Date: Aug. 8, 2013

(54) METHOD AND SYSTEM FOR SUPPORTING COMPONENT DESIGN

(71) Applicants: Kiyoshi KUMAGAI, Yokohama (JP); Toshiyuki ONO, Kawasaki (JP); Yasuharu NAMBA, Yokohama (JP); Masataka ARAKI, Kawasaki (JP); Yukinori TERAHAMA, Yokohama (JP); Hidenori AZUSHIMA, Kawasaki (JP); Kyoji NISHIDA, Kawasaki (JP); Koji OKADA, Kawasaki (JP)

(72) Inventors: Kiyoshi KUMAGAI, Yokohama (JP); Toshiyuki ONO, Kawasaki (JP); Yasuharu NAMBA, Yokohama (JP); Masataka ARAKI, Kawasaki (JP); Yukinori TERAHAMA, Yokohama (JP); Hidenori AZUSHIMA, Kawasaki (JP); Kyoji NISHIDA, Kawasaki (JP); Koji OKADA, Kawasaki (JP)

(73) Assignee: Hitachi, Ltd.

(21) Appl. No.: 13/568,704

(22) Filed: Aug. 7, 2012

(30) Foreign Application Priority Data
Aug. 15, 2011 (JP) 2011-177399

(51) Int. Cl. G06Q 10/06

(52) U.S. Cl. CPC G06Q 10/06315
USPC 705/7.25

(57) ABSTRACT

With an object of improving system maintainability, a system which evaluates a maintenance man-hour cost of a component quantitatively is provided, and consequently when a system designer designs a component which is a unit of a subsystem obtained by putting a function of a business application and data together, it is made possible to design the component with a minimum maintenance man-hour cost by extracting a maintenance pattern obtained by patterning an influence extension place, an amendment man-hour cost, and the like at time of maintenance on the basis of maintenance history information and evaluating a maintenance man-hour cost of the component according to the maintenance pattern.

### INCORPORATION BY REFERENCE

The present application claims priority from Japanese application JP2011-177399 filed on Aug. 15, 2011 the content of which is hereby incorporated by reference into this application.

### BACKGROUND OF THE INVENTION

The present invention relates to a system design method of a business application or the like, and in particular to a technique for a system designer to design a component which is a unit of a subsystem obtained by putting a function of a business application and data together, aria a communication network.

At the present time it is conducted to utilize a system such as a business application to execute a business. Such a system often consists of a plurality of components, and its configuration tends to become complicated. Several techniques for managing such a system have been proposed. One of them is disclosed in JP-A-2009-129355. JP-A-2009-129355 states, “the problem is solved by a component division support device having a dependency analysis part for using policy data which define illegal dependency to detect dependency against the policy from among dependencies and using a plan to improve the dependency against the policy to output a candidate of an improvement plan of the dependency against the detected policy.”

Another technique is proposed in “Strategy-Based Design of Reusable Business Components,” IEEE Trans. Systems, Man, and Cybernetics, vol. 34, no 4, pp 460-474, Nov. 2004. This paper describes a technique for evaluating maintainability of a component by using a plurality of indexes such as cohesion, coupling and complexity on the basis of dependencies among objects which constitute the component.

### SUMMARY OF THE INVENTION

In large scale system development, attention is paid to Component-Based Development in which a system to be developed is divided into units of subsystems called components and development and maintenance are conducted for each component. In the Component-Based Development, it becomes important to minimize the maintenance man-hour cost by extracting a function and data having a mutual dependency and assigning the function and data to the same component accurately, aiming at system maintainability improvement. For example, since “contract check function” and “contract data” having a mutual dependency have a high possibility that amendments at the time of maintenance will occur simultaneously, it is desirable to assign the contract check function” and “contract data” to the same component and thereby reduce the maintenance man-hour cost.

According to the technique disclosed in JP-A-2009-129355, illegal dependency which affects the maintainability such as mutual calling between functions is extracted and improved on the basis of a policy which defines dependency between objects. However, the maintenance man-hour cost for each component cannot be measured quantitatively. For example, it is impossible to measure the maintenance man-hour cost quantitatively with respect to a plurality of component design plans and judge a design plan having the highest maintainability.

In “Strategy-Based Design of Reusable Business Components,” IEEE Trans. Systems, Man, and Cybernetics, vol 34, no 4, pp 460-474, Nov 2004, maintainability of a component is evaluated quantitatively by using a plurality of indexes. However, the maintenance man-hour cost itself cannot be measured. Furthermore, since only the dependency between objects is evaluated, “tendency of maintenance” and “range in charge of a maintenance man” based on domain characteristics of a business application are not reflected to evaluation of maintainability. For example, functions and data in which amendments at the time of maintenance are apt to occur and functions and data to which influence of amendments is apt to extend differ depending upon the domain characteristics of the business application. Furthermore, the maintenance man-hour cost changes depending upon whether one person in charge can cope with an amendment range at the me of maintenance or cooperation of a plurality of persons in charge is needed.

An object of the present invention is to provide a system which patterns the tendency of maintenance on the basis of past maintenance history information and evaluates a maintenance man-hour cost of a component quantitatively with due regard to a range in charge of a person in charge of maintenance.

In order to attain the object, the present invention supports design of a component which minimizes a maintenance man-hour cost by extracting a maintenance pattern obtained by patterning an influence extension place, an amendment man-hour cost, and the like, and evaluating the maintenance man-hour cost of the component according to the maintenance pattern. As a more concrete configuration, for example, a configuration described hereafter is adopted.

The present application includes a plurality of means for attaining the object. As an example, however, a component design supporting method which supports a system designer, who accumulates amendment places and amendment man-hour costs at the time of maintenance as maintenance pattern information on the basis of maintenance history information of a system and newly designs a component of the system, in design of a component with high maintainability by measuring a maintenance man-hour cost of the component on the basis of the maintenance pattern information includes a maintenance history information registration step of accepting an amendment place and an amendment man-hour cost at the time of maintenance from a person in charge of maintenance of the system and storing them as the maintenance history information, a maintenance pattern extraction step of patterning an amendment place and an amendment man-hour cost at the time of maintenance and extracting maintenance pattern information on the basis of the maintenance history information, a component information registration step of accepting design information of a component obtained by dividing the system to subsystems from the system designer and storing the design information of the component as component information, a maintenance man-hour cost evaluation step of calculating a maintenance man-hour cost of the component considered to occur at the time of maintenance of the system on the basis of the component information and the maintenance pattern information, and a step of providing the system designer with information of the maintenance man-hour cost of the component calculated at the maintenance man-hour cost evaluation step via a communication network.

According to the present invention, it is possible in development of a system such as a business application to evaluate the maintenance man-hour cost of a component quantitatively and develop a business application which is higher in maintainability as compared with the conventional technique.

Other objects, features and advantages of the invention will become apparent from the following description of the embodiments of the invention taken in conjunction with the accompanying drawings.

### BRIEF DESCRIPTION OF THE DRAWINGS

FIG. 1 is an example of a configuration diagram of a component design supporting system;

FIG. 2 shows an example of a typical hardware configuration of a computer used in the component design supporting system;

FIG. 3 shows an example of a flew chart of hole processing of component design supporting;

FIG. 4 shows an example of a flow chart processing of amendment target pattern extraction;

FIG. 5 slows an example of a flow chart of processing of influence extension pat extraction;

FIG. 6 shows an example of a flow chart of processing of the maintenance man-hour cost evaluation;

FIG. 7 shows an example of a maintenance history information table;

FIG. 8 shows an example of a function -dictionary information table;

FIG. 9 shows an example of a data dictionary information table;

FIG. 10 shows an example of a maintenance history object information table;

FIG. 11 shows an example of an amendment target pattern information table;

FIG. 12 shows an example of an influence extension pattern information table;

FIG. 13 shows an example of a component information table;

FIG. 14 shows an example of an information table of persons in charge of maintenance;

FIG. 15 shows an example of an influence extension prediction information table;

FIG. 16 shows an example of a maintenance man-hour cost information table;

FIG. 17 is a concept diagram showing an extraction image of a maintenance pattern based on maintenance history information;

FIG. 18 is a concept diagram showing an image of a component design plan;

FIG. 19 is a concept diagram showing an image of influence extension at the time of maintenance; and

FIG. 20 shows an example of a screen of a component design supporting function.

### DESCRIPTION OF THE EMBODIMENTS

Hereafter, an embodiment of the present invention will be described with reference to the drawings.

When designing a component with an object of improving maintainability in design of a system such as a business application, a component design supporting system 2 patterns an influence extension place and an amendment man-hour cost at the time of maintenance on the basis of past maintenance history information and evaluates a maintenance man-hour cost of the component. In the present embodiment, an example of the component design supporting system 2 will be described.

Hereafter, a component design supporting system according to an embodiment of the present invention which is run with such a background will be described in detail.

### ===Outline of Embodiment===

In the present embodiment, a case where a system maintenance information (inf) input system 1 accepts input of maintenance history information from a person in charge of maintenance or the like and transmits it to a component (comp) design supporting system 2, the component design supporting system 2 stores the maintenance history information and calculates influence extension pattern information such as influence extension places and the amendment man-hour (MH) cost at the time of maintenance on the basis of the maintenance history information, a component design information input/output system 3 accepts input of component information from a component designer or the like and transmits the component information to the component design supporting system 2, and the component design supporting system 2 evaluates the maintenance man-hour cost of the component from the influence extension pattern information on the basis of the component information and transmits an evaluation result to the component design information input/output system 3 will now be described.

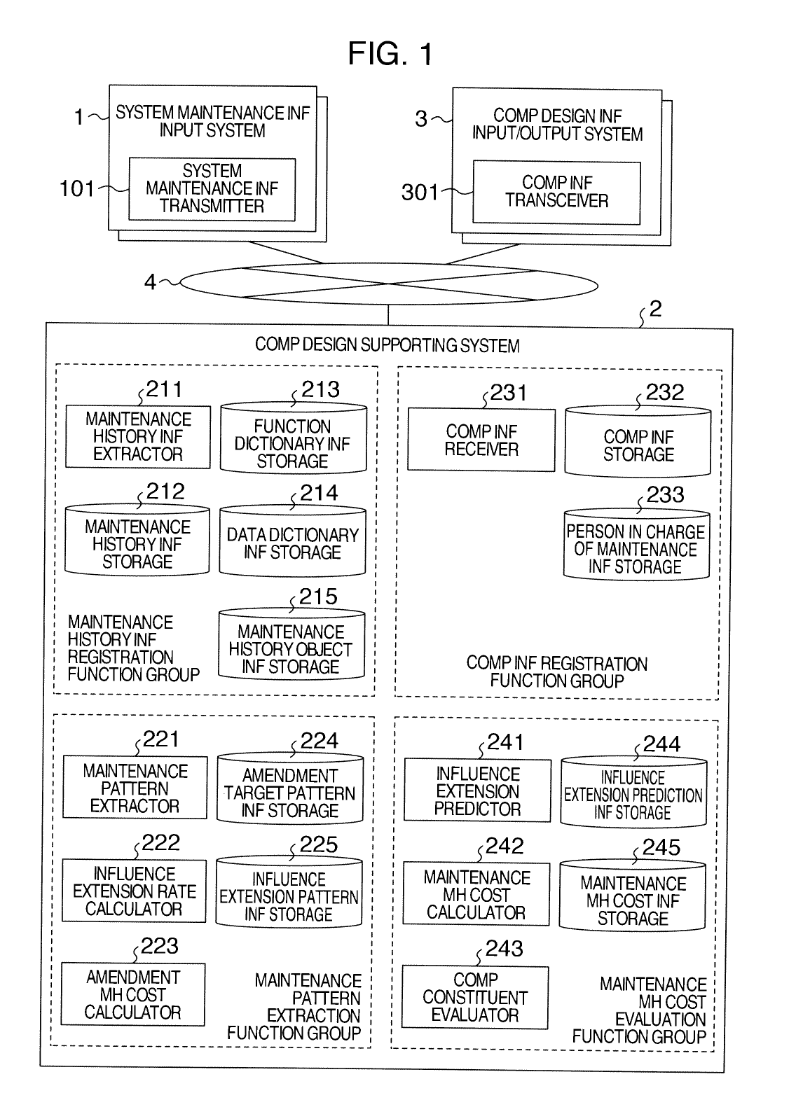

FIG. 1 shows a system configuration in the present embodiment. In the present system, the system maintenance information input system 1, the component design supporting system 2, and the component design information input/output system 3 are connected via a communication network 4. By the way, a plurality of system maintenance information input systems 1 and a plurality of component design information input/output systems 3 may be connected to the communication network 4. The communication network 4 can be a LAN, Internet, or another arbitrary wired or wireless network. Each of the system maintenance information input system 1, the component design supporting system 2, and the component design information input/output system 3 is a computer including a CPU for conducting operation processing, a storage device for storing data and programs (such as, for example, RAMs, ROMs, and a hard disk) and a communication device for communicating with external devices via the network 4.

### ===Hardware Configuration===

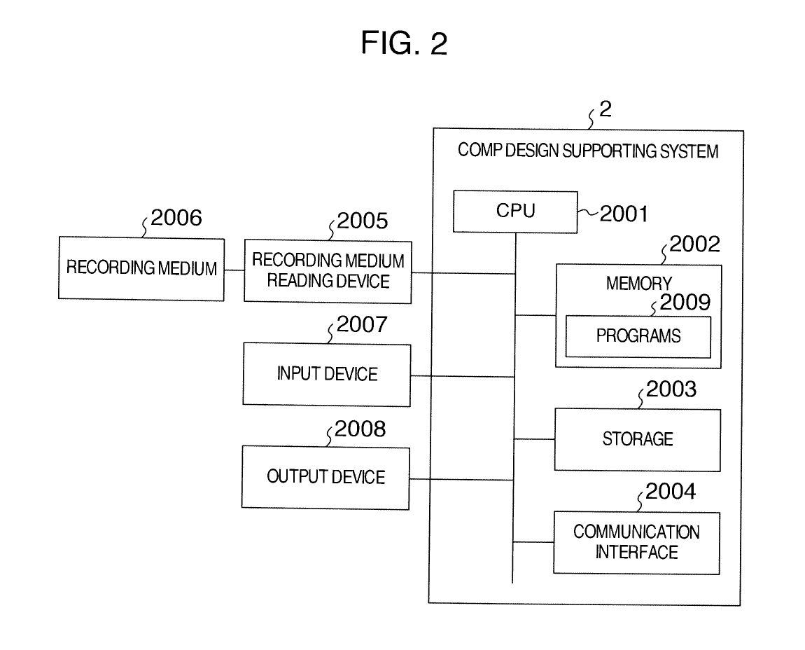

FIG. 2 shows a typical hardware configuration of a computer used in the component design supporting system 2. The computer having the configuration shown in FIG. 2 is used in the system maintenance information input system 1 and the component design information input/output system 3 as well. As shown in FIG. 2, the component design supporting system 2 has a CPU 2001, a memory 2002, a storage 2003, a communication interface 2004, a recording medium reading device 2005 a recording medium 2006, an input device 2007, and an output device 2008.

The CPU 2001 exercises general control on the component design supporting system 2. The CPU 2001 implements various functions by executing programs 2009 stored in the memory 2002. The recording medium reading device 2005 is a device for reading a program or data stored on the recording medium 2006. For example, therefore, a program 2009 stored in the memory 2002 can be read from the recording medium 2006 by using the recording medium reading device 2005, and stored into the memory 2002. By the way, processing in the present embodiment described later is implemented by execution of an operation conducted by the CPU 2001 in accordance with a program. As the recording medium 2006, for example, a CD-ROM, a DVD-ROM, a hard disk, a flexible disk, a semiconductor memory, magnetic tape or the like can be used. The recording medium reading device 2005 can be either of a form incorporated in the component design supporting system 2 and a form provided externally to the component design supporting system 2. The input device 2007 is used by an operator or the like to input data or the like to the component design supporting system 2. As the input device 2007, for example, a keyboard, a mouse, a microphone or the like is used. The output device 2008 is a device for outputting information to the external. As the output device 2008, for example, a display, a printer, a speaker or the like is used. The communication interface 2004 is a device connected to the communication network 4 to conduct communication with an external device such as the system maintenance information input system 1 or the component design information input/output system 3

### ===System Maintenance Information Input System 1===

In the system maintenance information input system 1 shown in FIG. 1, a system maintenance information transmitter 101 has a function of accepting input of maintenance history information from a person in charge of system maintenance and transmitting the maintenance history information to the component design supporting system 2.

### ===Component Design Supporting System 2===

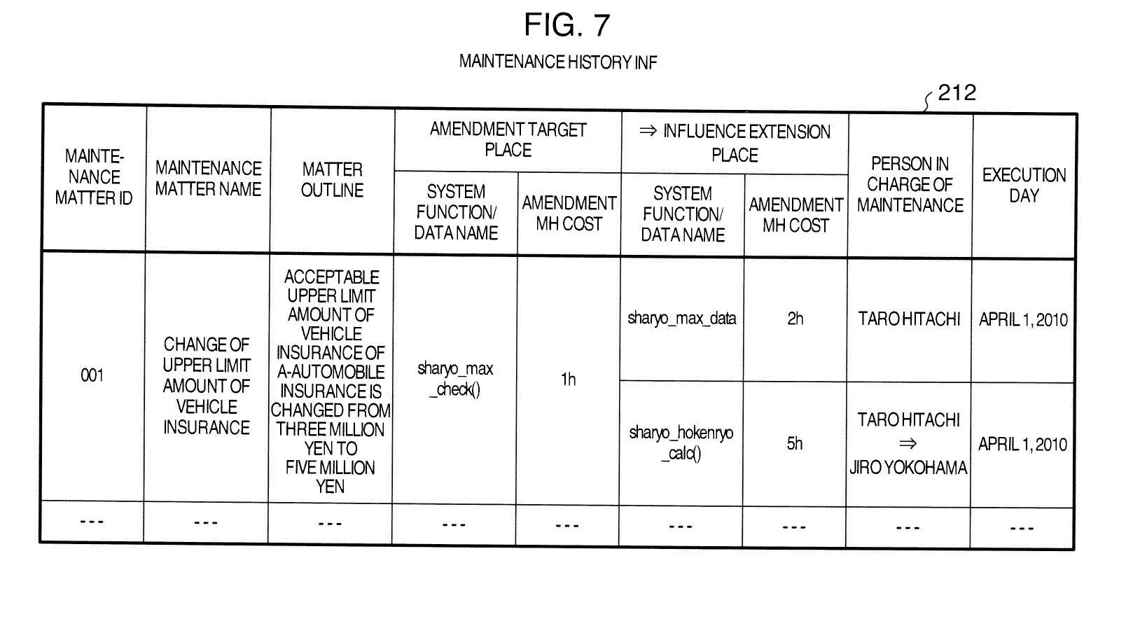

In the component design supporting system 2 shown in FIG. 1, a maintenance history information storage 212 stores a maintenance matter ID, a maintenance matter name, a matter outline, a system function/data name of an amendment target place, an amendment man-hour cost of the amendment target place, a system function/data name of an influence extension place, an amendment man-hour cost of the influence extension place, a person in charge of maintenance, and an execution day as shown in FIG. 7.

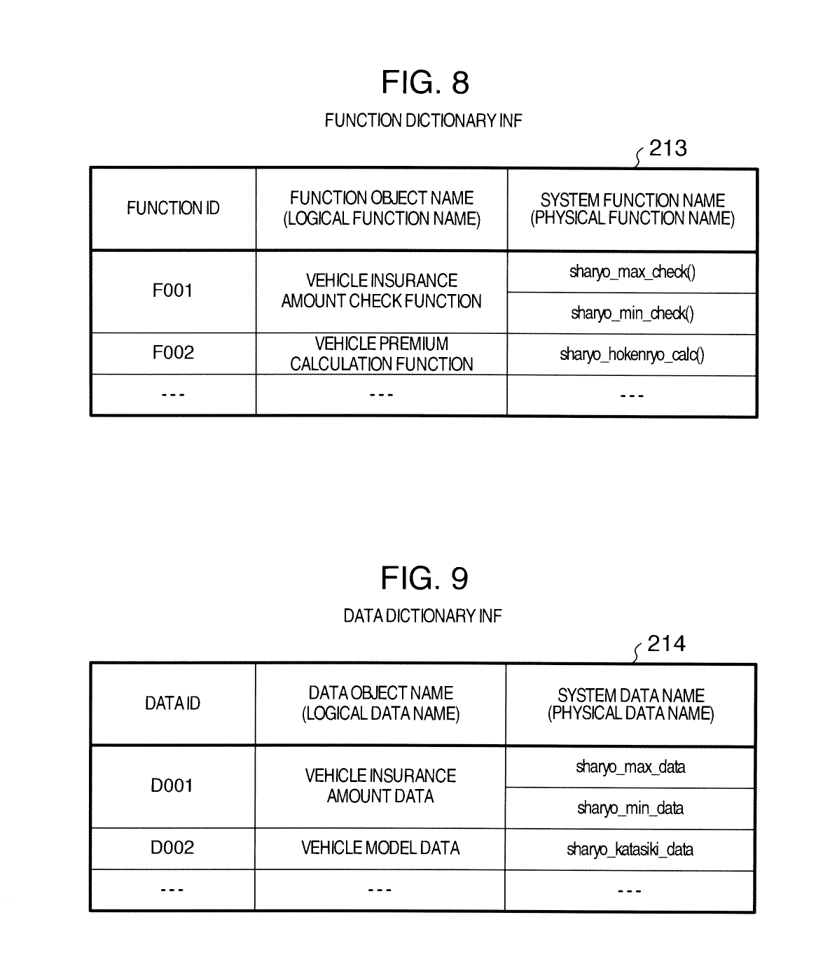

A function dictionary information storage 213 stores a function ID, a function object name, and a system function name as shown FIG. 8.

A data dictionary information storage 214 stores a data ID, a data object name, and a system data name as shown in FIG. 9.

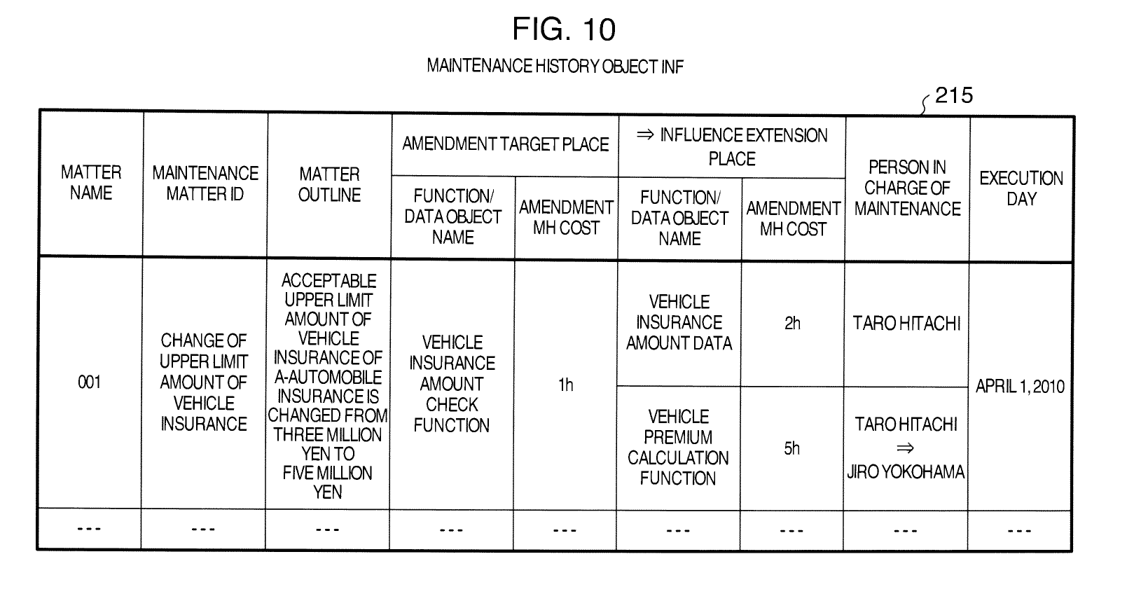

A maintenance history object information storage 215 stores a maintenance matter ID, a maintenance matter name, a matter outline, a function data object name of an amendment target place, an amendment man-hour cost of the amendment target place, a function/data object name of an influence extension place, an amendment man-hour cost of the influence extension place, a person in charge of maintenance, and an execution day as shown in FIG. 10.

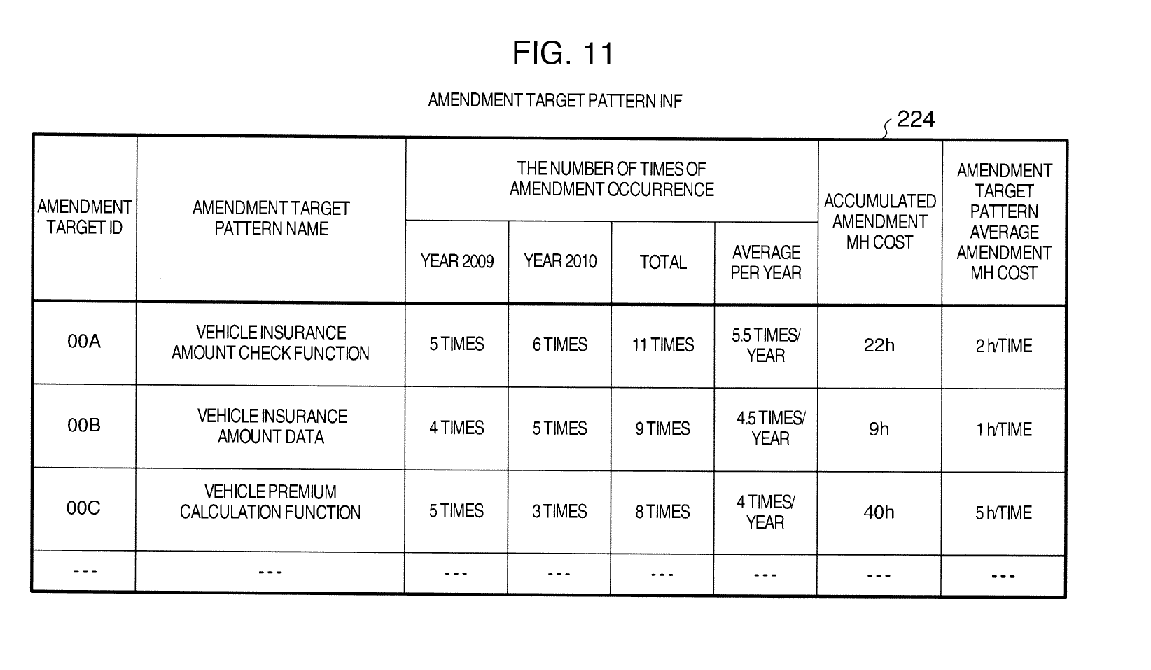

An amendment target pattern information storage 224 stores an amendment target ID, an amendment target pattern name, the number of times of amendment occurrences and an amendment target pattern average amendment man-hour cost as shown in FIG. 11.

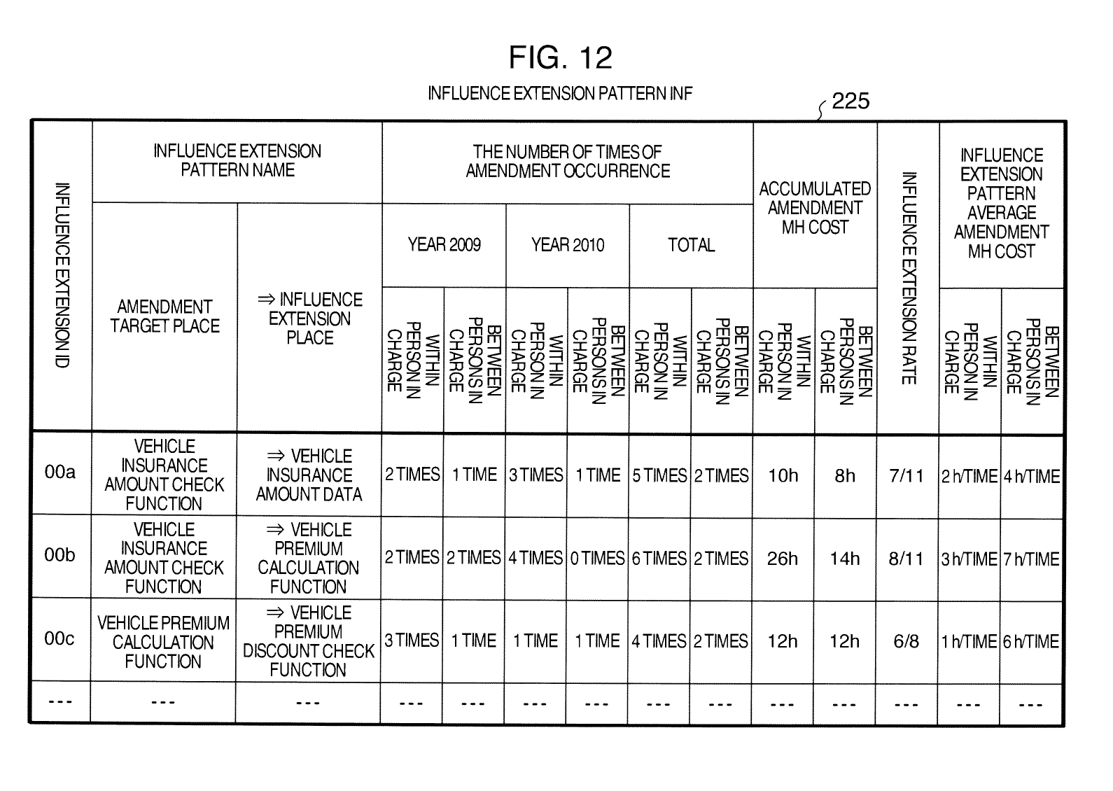

An influence extension pattern information storage 225 stores an influence extension ID, an influence extension pattern name (an amendment target place, an influence extension place), the number of times of amendment occurrence, an accumulated amendment man-hour cost, an influence extension rate, and an influence extension pattern average amendment man-hour cost (within a person in charge, between persons in charged as shown in FIG. 12.

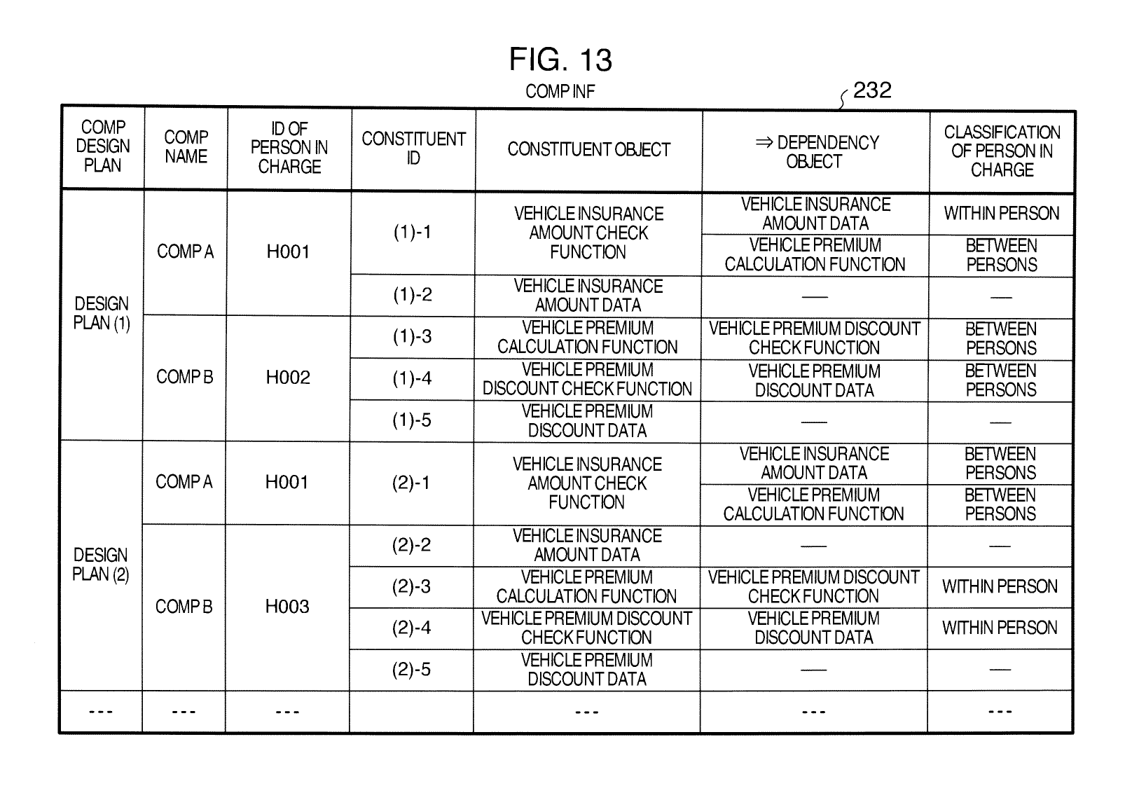

A component information storage 232 stores a component design plan, a component name, an ID of a person in charge, a constituent ID, a constituent object, a dependency object, and a classification of a person in charge as shown in FIG. 13.

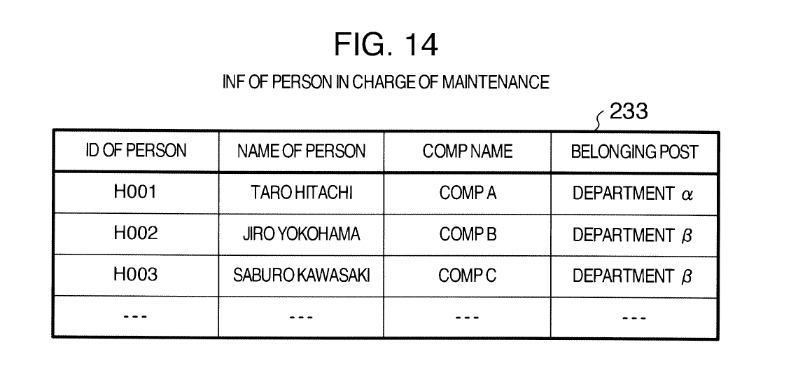

A person in charge of maintenance information storage 233 stores an ID of a person in charge, a name of a person in charge, a component name in charge, and a belonging post as shown in FIG. 14.

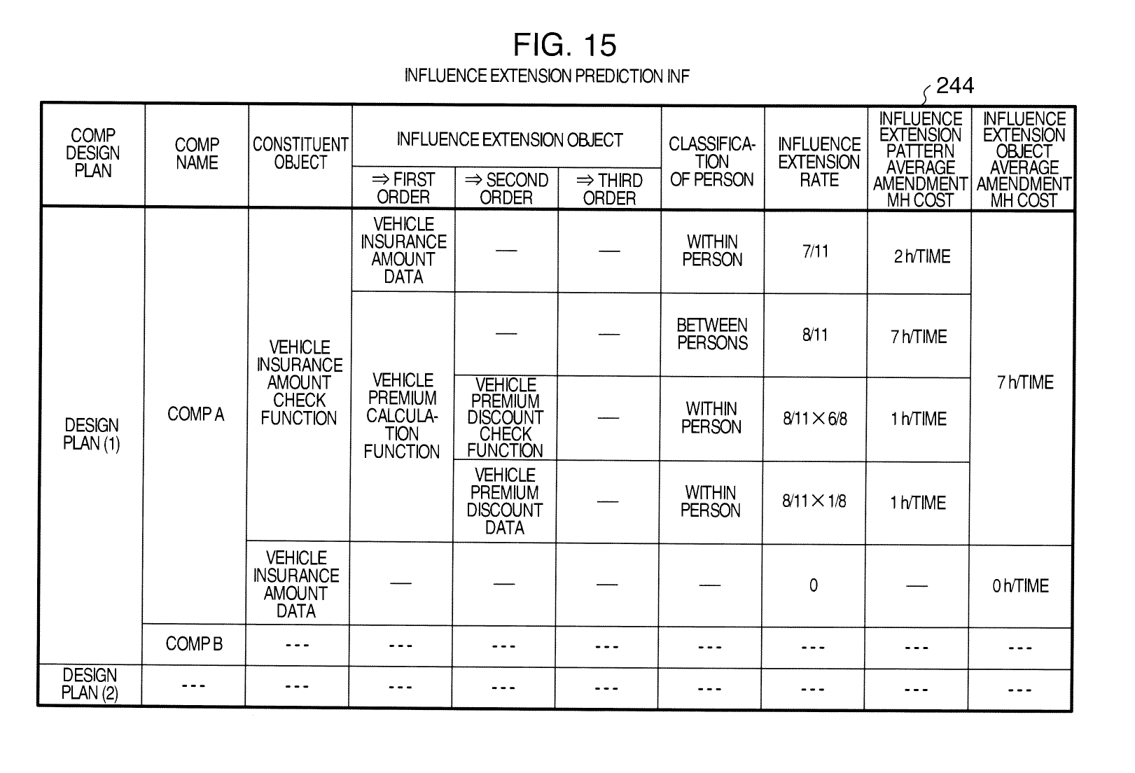

An influence extension prediction information storage 244 stores a component design plan, a component name, a constituent object, an influence extension object, a classification of a person in charge, an influence extension rate, an influence extension pattern average amendment man-hour cost, and an influence extension object average amendment man-hour cost as shown in FIG. 15.

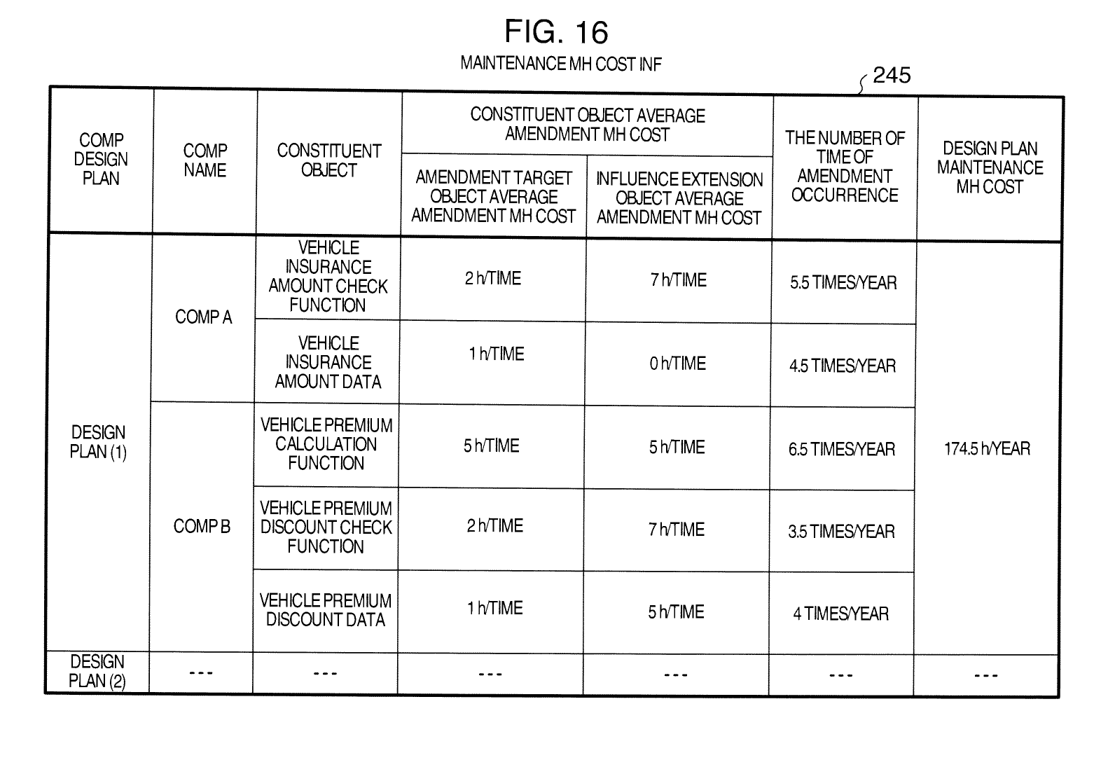

A maintenance man-hour cost information storage 245 stores a component design plan, a component name, a constituent object, a constituent object average amendment man-hour cost, the number of times of amendment occurrence, and a design plan maintenance man-hour cost as shown in FIG. 16.

A maintenance history information extractor 211 has a function of receiving maintenance history information from the system maintenance information input system 1, storing the received maintenance history information into the maintenance history information storage 212, converting a system function name in the maintenance history information which coincides with a system function name stored in the function dictionary information storage 213 to a function object name, converting a system data name in the maintenance history information which coincides with a system data name stored in the data dictionary information storage 214 to a data object name, and storing the data object name into the maintenance history object information storage 215.

A maintenance pattern extractor 221 has a function of acquiring maintenance history object information stored in the maintenance history object information storage 215, extracting an amendment target place as an amendment target pattern, calculating the number of times of occurrence of an amendment target pattern and the average amendment man-hour cost, storing them into the amendment target pattern information storage 224, extracting a combination of an amendment target place and an influence extension place as an influence extension pattern, calculating the number of times of occurrence of an influence extension pattern and the average amendment man-hour cost, and storing them into the influence extension pattern information storage 225.

An influence extension rate calculator 222 has a function of calculating an influence extension rate every influence extension pattern stored in the influence extension pattern information storage 225 and storing the influence extension rate into the influence extension pattern information storage 225.

An amendment man-hour cost calculator 223 has a function of calculating an average amendment man-hour cost every amendment target pattern stored in the amendment target pattern information storage 224, storing the average amendment man-hour cost into the amendment target pattern information storage 224, calculating an average amendment man-hour cost every influence extension pattern stored in the influence extension pattern information storage 225, and storing the average amendment man-hour cost into the influence extension pattern information storage 225.

A component information receiver 231 has a function of receiving component information and person in charge of maintenance information from the component design information input/output system 3, and storing them into the component information storage 232 and the person in charge of maintenance information storage 233.

An influence extension predictor 241 has a function of extracting an influence extension object on the basis of a combination of a constituent object and a dependency object stored in the component information storage 232, conducting matching with influence extension patterns stored in the influence extension pattern information storage 225, acquiring an influence extension rate and an influence extension average amendment man-hour cost in a coincident influence extension pattern, calculating an influence extension object average amendment man-hour cost, and storing it into the influence extension prediction information storage 244.

A maintenance man-hour cost calculator 242 has a function of calculating a predicted maintenance man-hour cost every component design plan on the basis of the influence extension object average amendment man-hour cost stored in the influence extension prediction information storage 244 and the amendment target pattern average amendment man-hour cost stored in the amendment target pattern information storage 224, and storing the predicted maintenance man-hour cost into the maintenance man-hour cost information storage 245.

A component constituent object evaluator 243 has a function of acquiring the maintenance man-hour cost information from the maintenance man-hour cost information storage 245 and transmitting it to the component design information input/output system 3 as an evaluation result of the component.

### ===Component Design Information Input/Output System 3===

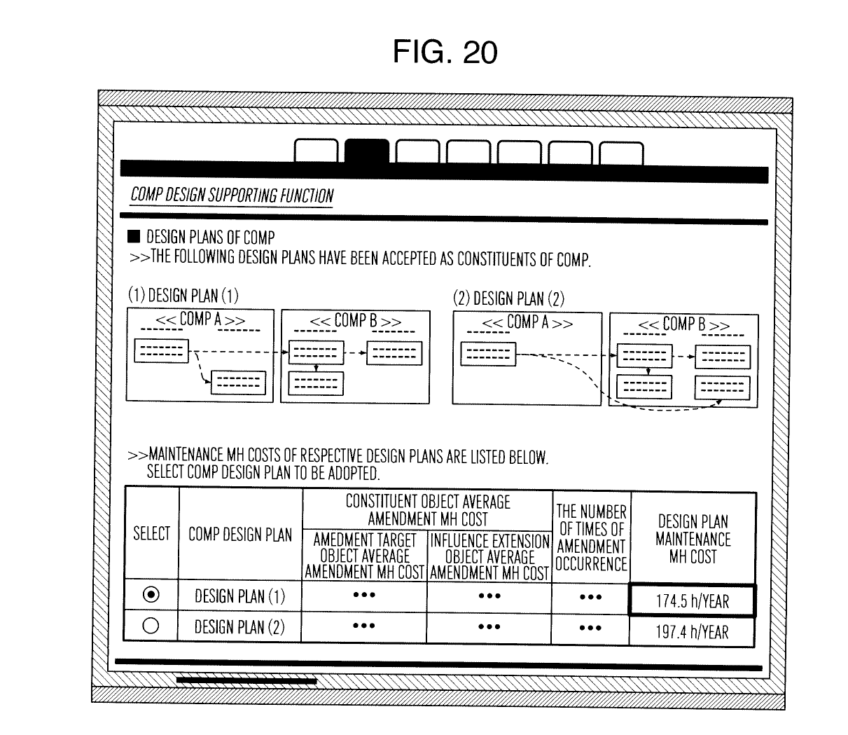

In the component design information input/output system 3 shown in FIG. 1, a component information transceiver 301 has a function of accepting input of component design information and person in charge of maintenance information from the component designer, transmitting them to the component design supporting system 2, receiving an evaluation result of the component from the component design supporting system 2, and displaying a component evaluation result as shown in FIG. 20.

### ===Outline of System Processing===

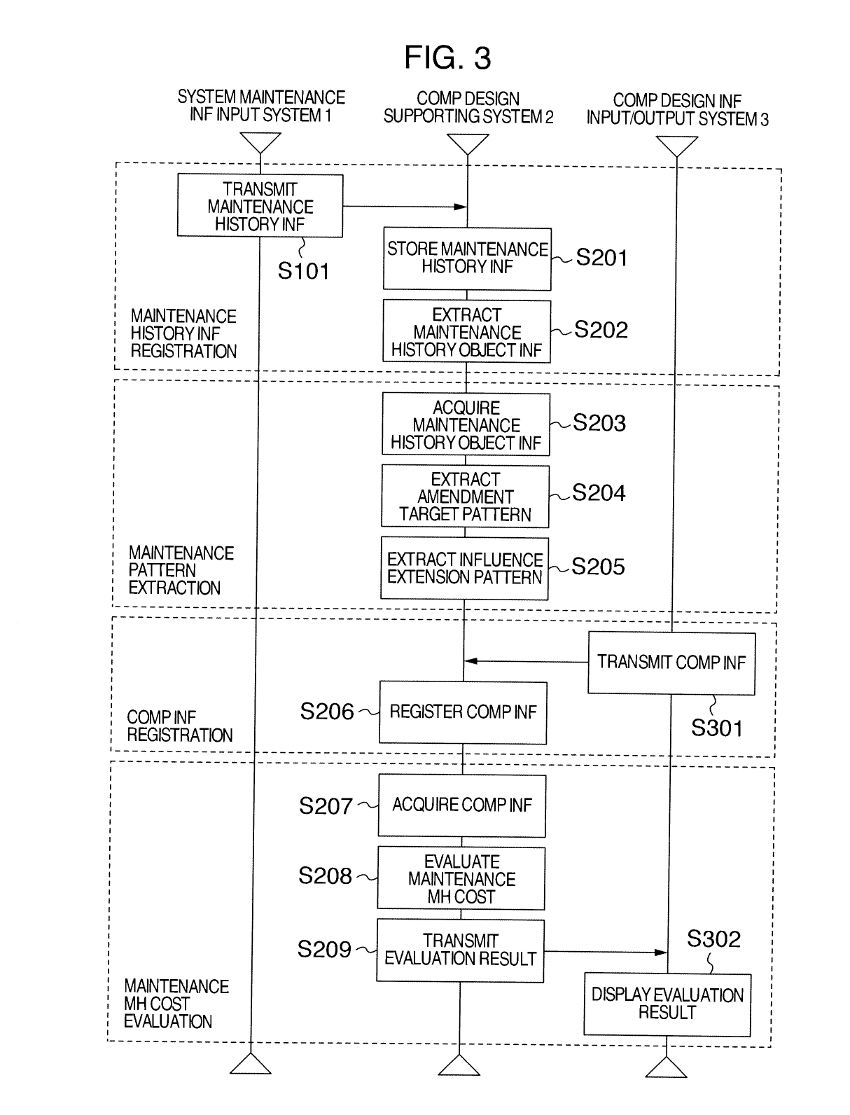

FIG. 3 is a flow diagram showing a processing flow, in the component design supporting system according to the present embodiment, which accepts maintenance history information of the system, extracts a maintenance pattern, accepts component design information, evaluates the maintenance man-hour cost of the component, and gives a notice of a result of the evaluation.

FIG. 3 shows a flow of a case where the system maintenance information input system 1 transmits maintenance history information to the component design supporting system 2, the component design supporting system 2 converts the maintenance history information to generalized maintenance history object information and extracts a maintenance pattern from the maintenance history object information, and the component design information input system 3 transmits component information to the component design supporting system 2, and the component design supporting system 2 applies the maintenance pattern to the component information, evaluates the maintenance man-hour cost, transmits a result of the evaluation to the component design information input system 3, and thereby supports component design. Furthermore, processing shown in FIG. 3 is implemented by execution of a program conducted by a CPU in each of the system maintenance information input system 1, the component design supporting system 2, and the component design information input/output system 3. This point has been described earlier.

Processing S101 is processing executed by the system maintenance information input system 1, processing S201 to processing S209 are processing executed by the component design supporting system 2, and processing S301 and processing S302 are processing executed by the component design input/output system 3.

### ===Processing of Maintenance History Information Registration===

Processing conducted when accepting registration of maintenance history information from a person in charge of system maintenance or the like will now be described. The processing aims at storing maintenance history information having high versatility by converting a system function/data name of a program level described in maintenance history information to a generalized function/data object name.

The processing will now be described with reference to FIG. 3. The system maintenance information transmitter 101 in the system maintenance information input system 1 accepts input of a maintenance matter ID, a maintenance matter name, a matter outline, a system function/data name of an amendment target place, an amendment man-hour cost of an influence extension place, a person in charge of maintenance, and an execution day as maintenance history information from a person in charge of maintenance or the like, and transmits them to the component design supporting system 2 (processing S101).

The maintenance history information extractor 211 in the component design supporting system 2 stores the maintenance history information received from the system maintenance information transmitter 101 in the system maintenance information input system 1 into the maintenance history information storage 212 (processing S201).

The maintenance history information extractor 211 in the component design supporting system 2 acquires maintenance history information stored in the maintenance history information storage 212. The maintenance history information extractor 211 compares a system function/data name of an amendment target place and a system function/data name of an influence extension place described in the maintenance history information in order of ascending maintenance matter ID with a system function name stored in the function dictionary information storage 213. Upon coincidence, the maintenance history information extractor 211 conducts conversion to a function object name. The maintenance history information extractor 211 compares the system function/data name of the amendment target place and the system function/data name of the influence extension place with a system data name stored in the data dictionary information storage 214. Upon coincidence, the maintenance history information extractor 211 conducts conversion to a data object name. The maintenance history information extractor 211 stores a maintenance matter ID, a maintenance matter name, a matter outline, a function/data object name of an amendment target place, an amendment man-hour cost of the amendment target place, a function/data object name of an influence extension place, an amendment man-hour cost of the influence extension place, a person in charge of maintenance, and an execution day into the maintenance history object information storage 215 (processing S202). For example, the maintenance history information extractor 211 converts a system function/data name sharyo_max_check( ) of an amendment target place in the maintenance history information to “vehicle insurance amount check function” in the function dictionary information, converts a system function/data name “sharyo_max_data” of an influence extension place to “vehicle insurance amount data” in the data dictionary information, and stores results obtained by the conversion into the maintenance history object information.

### ===Maintenance Pattern Extraction Processing===

Processing conducted when analyzing the maintenance history information and extracting a maintenance amendment pattern will now be described. The processing aims at classifying amendment at the time of maintenance into direct “amendment target place” and indirect “influence extension place” influenced by amendment, extracting maintenance patterns, calculating an influence extension rate and the amendment man-hour cost every maintenance pattern, and thereby constructing amendment pattern information having high precision.

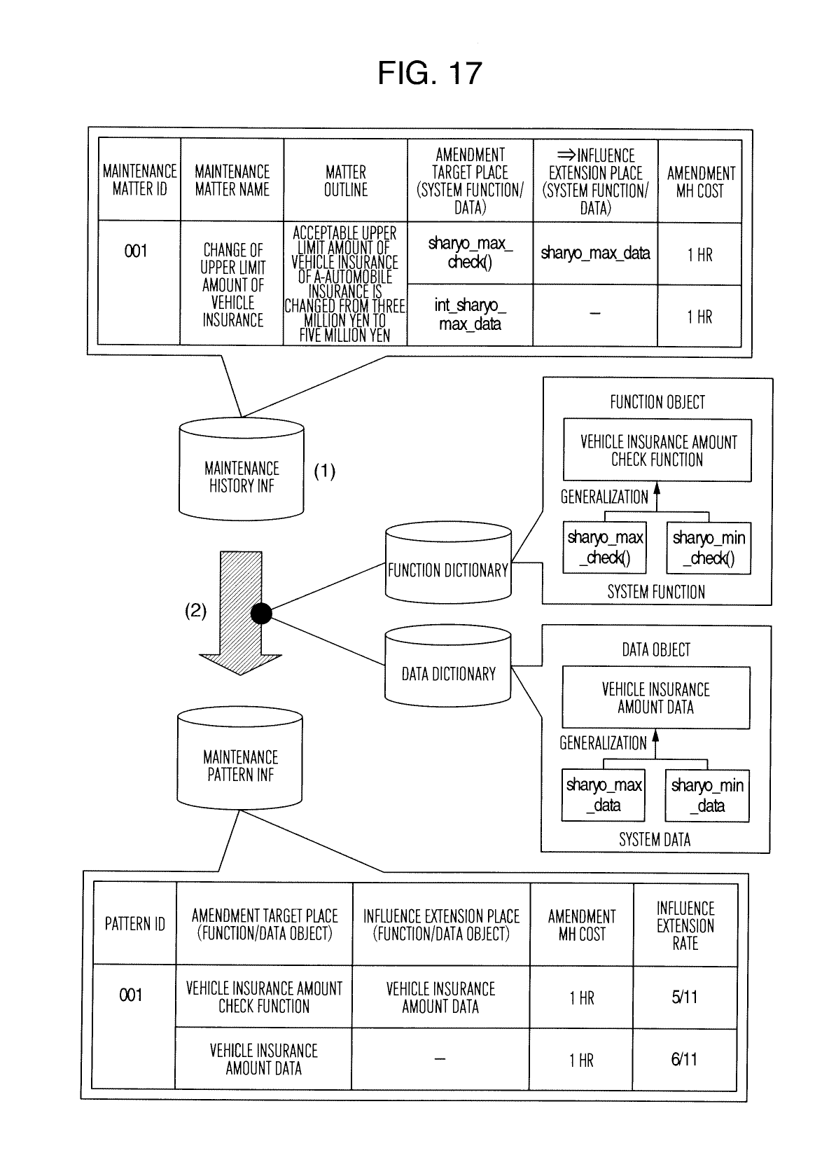

The concept is shown in FIG. 17. In process (1) of FIG. 17, the maintenance pattern is extracted at the generalized object level from the maintenance history information described in system program names. In process (2) of FIG. 17, the maintenance information is accumulated as maintenance patterns.

The maintenance pattern extractor 221 in the component design supporting system 2 acquires maintenance history object information from the maintenance history object information storage 215 (processing S203).

The maintenance pattern extractor 221 in the component design supporting system 2 executes processing for extracting an amendment target pattern from the maintenance history object information and stores the amendment target pattern into the amendment target pattern information storage 224 (processing S204).

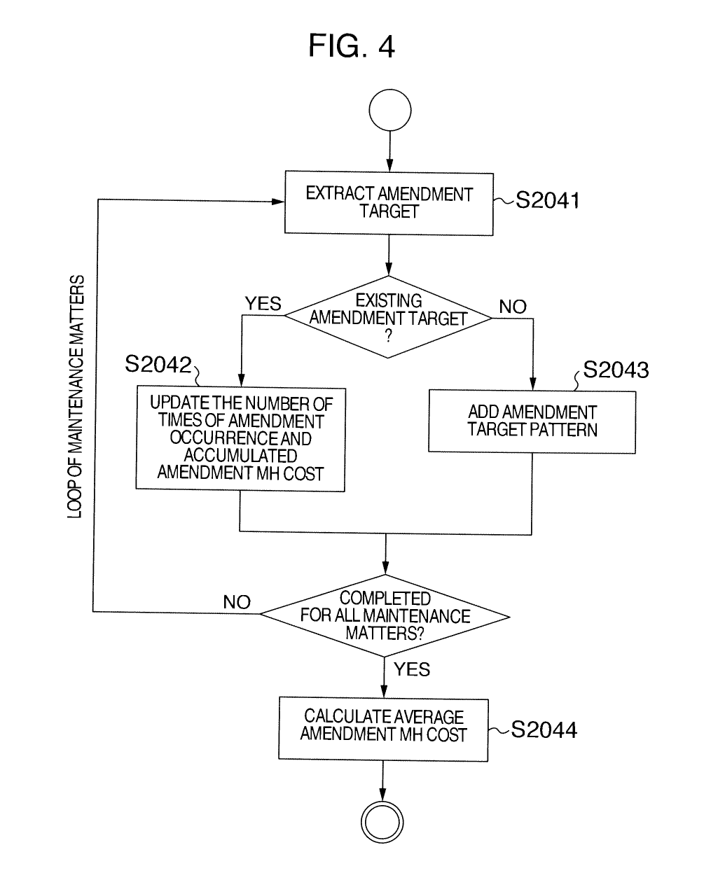

Details of the processing S204 are represented by processing S2041 to processing S2044 in a flow diagram shown in FIG. 4.

The processing S204 will now be described with reference to FIG. 4. FIG. 4 is a flow diagram showing a flow of processing for extracting an amendment target pattern from maintenance history object information.

The maintenance pattern extractor 221 in the component design supporting system a extracts a function/data object name of an amendment target place, an amendment man-hour cost of the amendment target place, a person in charge of maintenance, and an execution day from the maintenance history object information in order of ascending maintenance matter ID (processing S2041).

The maintenance pattern extractor 221 in the component design supporting system 2 compares a function/data object name of an amendment target place extracted from the maintenance history object information with an amendment target pattern name stored in the amendment target pattern information storage 224. Upon coincidence, the maintenance pattern extractor 221 calculates the number of times of amendment occurrence and an accumulated amendment man-hour cost in the amendment target pattern information on the basis of the amendment man-hour cost of the amendment target place and the execution day extracted from the maintenance history object information, and stores a result of the calculation into the amendment target pattern information storage 224 (processing S2042). For example, with respect to an amendment target pattern name “vehicle insurance amount check function” in the amendment target pattern information which coincides with a function/data object name “vehicle insurance amount check function” of an amendment target place in the maintenance history object information, on the basis of an execution day “April 1, 2010” and the amendment man-hour cost “1 h” of an amendment target place in the maintenance history object information, the maintenance pattern extractor 221 increases the count in the year 2010 of the number of times of amendment occurrence by one to “six times,” increases the accumulated amendment man-hour cost by “1 h” to “22 h,” and stores the results into the amendment target pattern information.

The maintenance pattern extractor 221 in the component design supporting system 2 compares a function/data object name of an amendment target place extracted from the maintenance history object information with an amendment target pattern name stored in the amendment target pattern information storage 224. If there aren't coincident names, then the maintenance pattern extractor 221 newly issues an amendment target ID, adds the function/data object name of the amendment target place as an amendment target pattern name, updates the number of times of amendment occurrence and the accumulated amendment man-hour cost in the amendment target pattern information on the basis of the amendment man-hour cost of the amendment target place and the execution day extracted from the maintenance history object information, and stores a result of the update into the amendment target pattern information storage 224 (processing S2043).

The processing S2041 to the processing S2043 are executed for each of the maintenance matters in the maintenance history object information.

The amendment man-hour cost calculator 223 in the component design supporting system 2 acquires the number of times of amendment occurrence and the accumulated amendment man-hour cost in amendment target pattern from the amendment target pattern information storage 224 in order of ascending amendment target ID, calculates an amendment target pattern average amendment man-hour cost, and stores the average amendment man-hour cost into the amendment target pattern information storage 224 (processing S2044). For example, with respect to an amendment target ID “00A” in the amendment target pattern information, the amendment man-hour cost calculator 223 acquires a sum total “11 times” of the number of times of amendment occurrence and the accumulated amendment man-hour “22 h,” calculates the amendment target pattern average amendment man-hour cost “2 h/time” of, and stores it into the amendment target pattern information.

The maintenance pattern extractor 221 in the component design supporting system 2 executes processing for extracting an influence extension pattern from the maintenance history object information and stores the influence extension pattern into the influence extension pattern information storage 225 (processing S205).

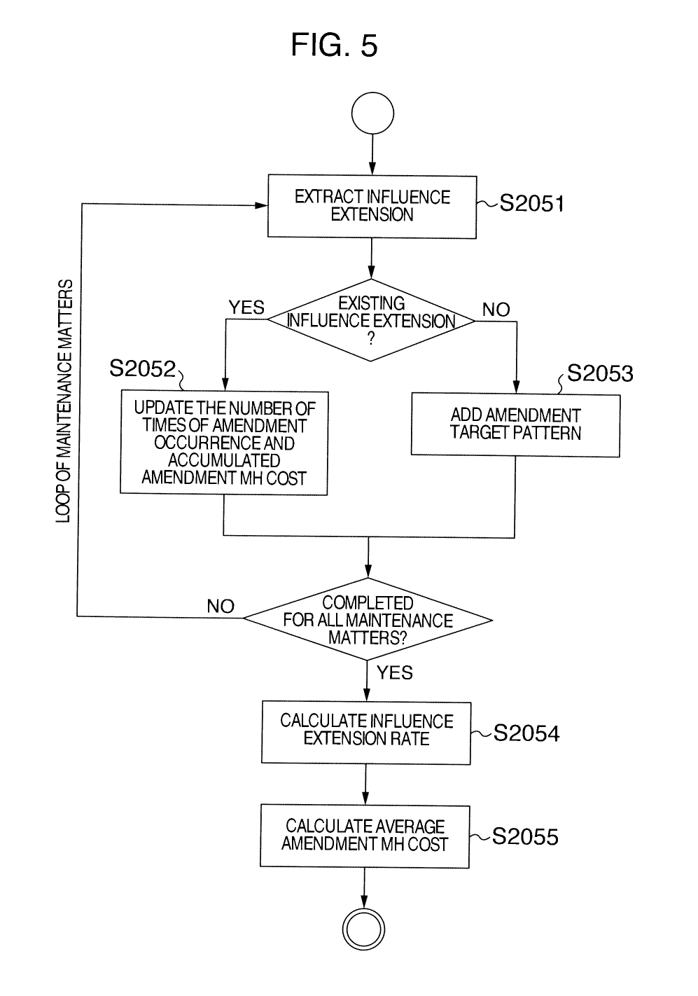

Details of the processing S205 are represented by processing S2051 to processing S2055 in a flow diagram shown in FIG. 5.

The processing S205 will now be described with reference to FIG. 5. FIG. 5 is a flow diagram showing a flow of processing for extracting an amendment target pattern from maintenance history object information.

The maintenance pattern extractor 221 in the component design supporting system 2 extracts a function/data object name of an amendment target place, a function/data object name of an influence extension place, an amendment man-hour cost of the influence extension place, a person in charge of maintenance, and an execution day from the maintenance history object information in order of ascending maintenance matter ID (processing S2051).

The maintenance pattern extractor 221 in the component design supporting system 2 compares a combination of the function/data object name of the amendment target place and the function/data meet name of the influence extension place with an influence extension pattern name stored in the influence extension pattern information storage 225. Upon coincidence, the maintenance pattern extractor 221 updates the number of times of amendment occurrence and the accumulated amendment man-hour cost in the influence extension pattern information on the basis of the amendment man-hour cost of the amendment target place, the person in charge of maintenance, and the registration day extracted from the maintenance history object information, and stores a result of the update into the influence extension pattern information storage 225 (processing S2052). For example, with respect to an influence extension pattern name “vehicle insurance amount check function→vehicle insurance amount data” in the influence extension pattern information which coincides with a combination of a function/data object name “vehicle insurance amount check function” of an amendment target place and a function/data object name “vehicle insurance amount data” of the influence extension place in the maintenance history object information, on the basis of the execution day “April 1, 2010,” the amendment man-hour cost “2 h” of the influence extension place, and a person in charge of maintenance “Taro Hitachi,” the maintenance pattern extractor 221 in the component design supporting system 2 increases a count of “within a person in charge” in the year 2010 of the number of times of amendment occurrence in the influence extension pattern information by one to “3 times,” increases “within a person in charge” of the accumulated amendment man-hour cost by “2 h” to “10 h,” and stores the results into the influence extension pattern information. By the way, if a name of a single person in charge is described in the column of person in charge of maintenance, the amendment is judged to be an amendment within the person in charge. If names of a plurality of persons in charge are described in the column of person in charge of maintenance, the amendment is judged to be an amendment between persons in charge.

The maintenance pattern extractor 221 in the component design supporting system 2 compares a combination of the function/data object name of the amendment target place and the function/data object name of the influence extension place with an influence extension pattern name stored in the influence extension pattern information storage 225 the influence extension pattern information storage 225. If there aren't coincident names, then the maintenance pattern extractor 221 newly issues an influence extension ID, adds the combination of the function/data object name of the amendment target place and the function/data object name of the influence extension place as an influence extension pattern name, calculates the number of times of amendment occurrence and the accumulated amendment man-hour cost in the influence extension pattern information on the basis of the amendment man-hour cost of the influence extension place, a person in charge of maintenance, and the registration day extracted from the maintenance history object information, and stores results of the calculation into the influence extension pattern information storage 22 (processing S2053).

The processing S2041 to the processing S2043 are executed for each of the maintenance matters in the maintenance history object information,

The influence extension rate calculator 222 in the component design supporting system 2 acquires an amendment target place in the influence extension pattern name and the sum total of the number of times of amendment occurrence from the influence extension pattern information storage 225 in order of ascending influence extension ID, conducts a search in the amendment target pattern information storage 224, acquires the sum total of the number of times of amendment occurrence in an amendment target pattern name which coincides with the amendment target place in the influence extension pattern name, and calculates the influence extension rate (processing S2054). For example, with respect to an influence extension ID “00a” in the influence extension pattern information, the influence extension rate calculator 222 acquires a sum total “11 times” of the number of times of amendment occurrence for an amendment target pattern name “vehicle insurance amount check function” in the amendment target pattern information which coincides with an amendment target place “vehicle insurance amount check function” in the influence extension pattern name, calculates an influence extension rate “(5 times+2 times)±11” on the basis of a sum total of the number of times of amendment occurrence “within person in charge: 5 times, and between persons in charge: 2 times” in the influence extension pattern information, and stores the influence extension rate into the influence extension pattern information. Here, the influence extension rate is defined as a value obtained by dividing, the number of times of amendment occurrence in the influence extension pattern by the number of times of amendment occurrence of the amendment target place, in the influence extension pattern (amendment target place→influence extension place).

The amendment man-hour cost calculator 223 in the component design supporting system 2 acquires the number of times of amendment occurrence and the accumulated amendment man-hour cost from the influence extension pattern information storage 225 in order of ascending influence extension ID, calculates an influence extension pattern average amendment man-hour cost, and stores the average amendment man-hour cost into the influence extension pattern information storage 225 (processing S2055). For example, with respect to an influence extension ID “00a” in the influence extension pattern information, the amendment man-hour cost calculator 223 acquires a sum total of the number of times of amendment occurrence “within person in charge: 5 times, and between persons in charge: 2 times” and an accumulated amendment man-hour cost “within person in charge: 10 h, and between persons in charge: 8h,” calculates an influence extension pattern average amendment man-hour cost “within person in charge: 2 h/time, and between persons in charge: 4 h/time,” and stores it into the influence extension pattern information.

By the way, these kinds of the maintenance history analysis processing an be executed regularly or periodically such as once per month, or can be executed in real tune when a new contract is added

### ===Component Information Registration Process===

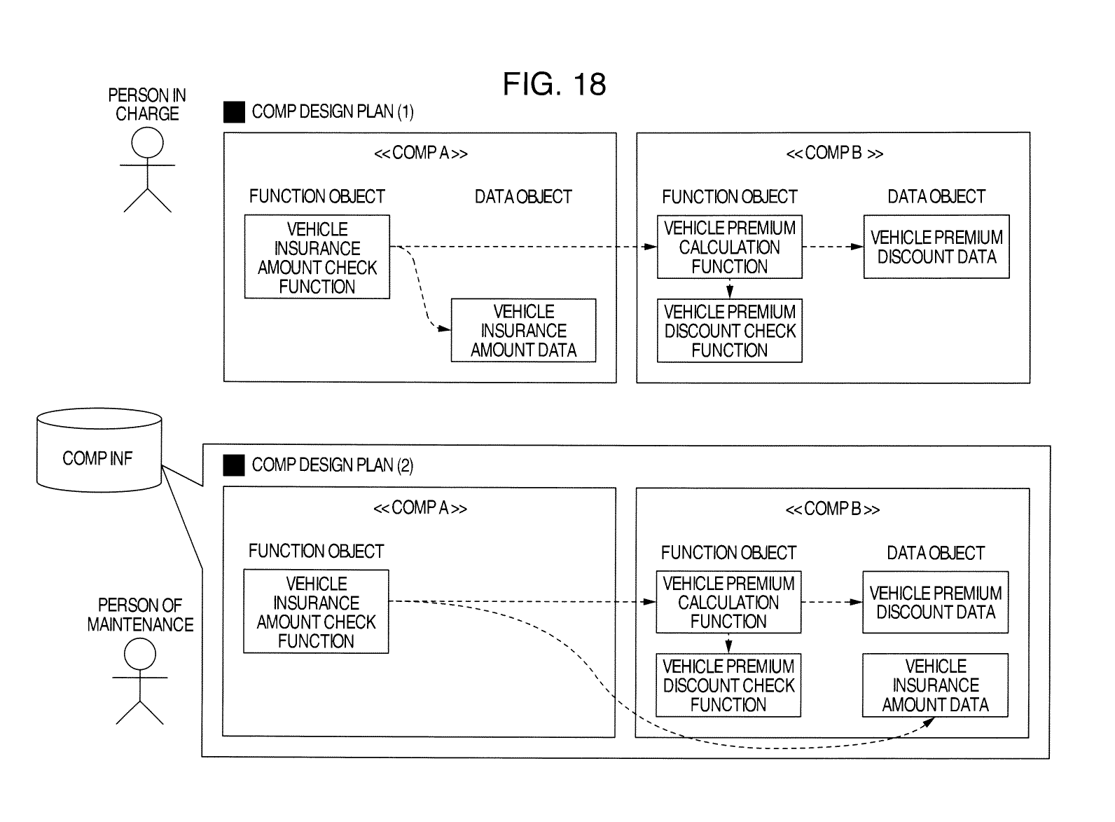

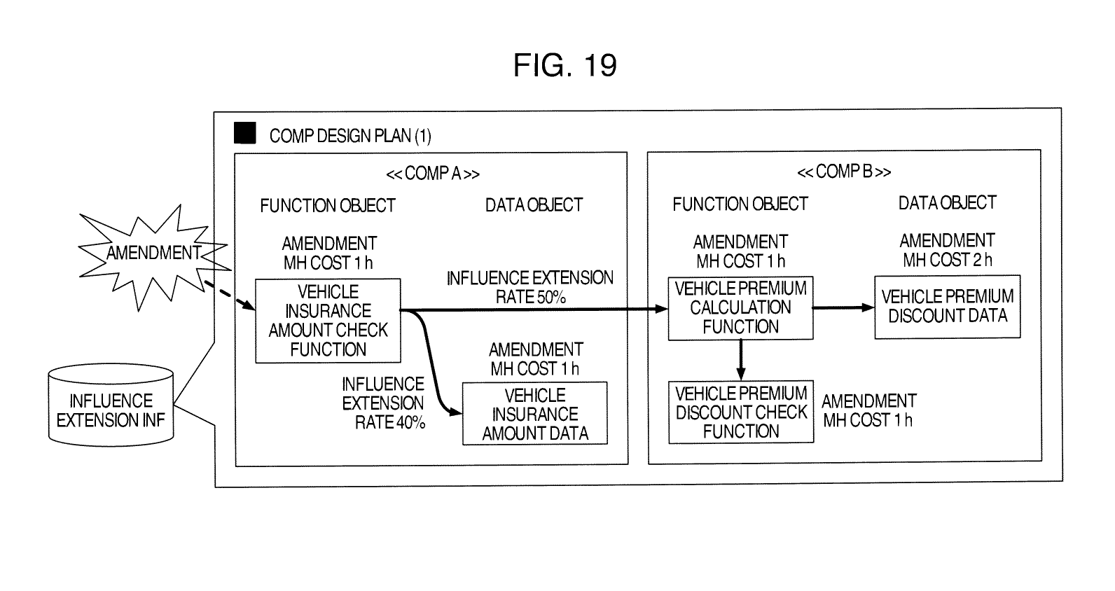

Processing conducted when accepting registration of component information which is a design plan of a component from the component designer or the like will now be described. An image of the component design plan is shown in FIG. 18. The processing aims at implementing high-precision evaluation of the maintenance man-hour cost with the charge range of a person in charge of maintenance into consideration by accepting information of the person in charge of maintenance of the component together with dependencies between objects in the component. For example, if the amendment range is closed with one person in charge of maintenance, the maintenance man-hour cost can be suppressed to a small value. If the amendment range extends over a plurality of persons in charge of maintenance, however the maintenance man-hour cost increases.

Referring back to FIG. 3, the component information transceiver 301 in the component design information input/output system 3 accepts input of a component design plan, a component name, an ID of a person in charge, a constituent ID, a constituent object, a dependency object, and a classification of person in charge as component information from the component designer or the like, accepts input of an ID of a person in charge, a person in charge name, a component name in charge, and a belonging post as information of person in charge of maintenance, and transmits them to the component design supporting system 2 (processing S301).

The component information receiver 231 in the component design supporting system 2 stores the component information received from the component information transceiver 301 in the component design information input/output system 3 into the component information storage 232, and stores the information of person in charge of maintenance received from the component information transceiver 301 in the component design information input/output system 3 into the person in charge of maintenance information storage 233 (processing S206).

### ===Processing of Maintenance Man-Hour Cost Evaluation===

Processing conducted when constructing influence extension prediction information by utilizing an amendment pattern extracted from the maintenance history with respect to a design plan of a component and evaluating a maintenance man-hour cost of the component will now be described. The processing aims at predicting influence extension between objects having dependencies on the basis of the maintenance history with respect to a design plan designed by the component designer and presenting a design plan which minimizes the maintenance man-hour cost, and thereby supporting a component design having high maintainability.

The influence extension predictor 241 in the component design supporting system 2 acquires a component design plan, a component name, a constituent object, a dependency object, and a classification of a person in charge as component information from the component information storage 232 (processing S207).

The influence extension predictor 241 in the component design supporting system 2 extracts a combination of a constituent object and an influence extension object in order of ascending constituent ID in the component information, and conducts comparison with an influence extension pattern name stored in the influence extension pattern information storage 225. The influence extension predictor 241 extracts an influence extension rate and an influence extension pattern average amendment man-hour cost in a coincident influence extension pattern, calculates an influence extension object average amendment man-hour cost on the basis of the influence extension rate and the influence extension pattern average amendment man-hour cost, calculates a constituent object average amendment man-hour cost and the number of times of amendment occurrence on the basis of amendment target pattern information stored in the amendment target pattern information storage 224 and the influence extension object average amendment man-hour cost, calculates a design plan maintenance man-hour cost, and stores it into the maintenance man-hour cost information storage 245 (processing S208).

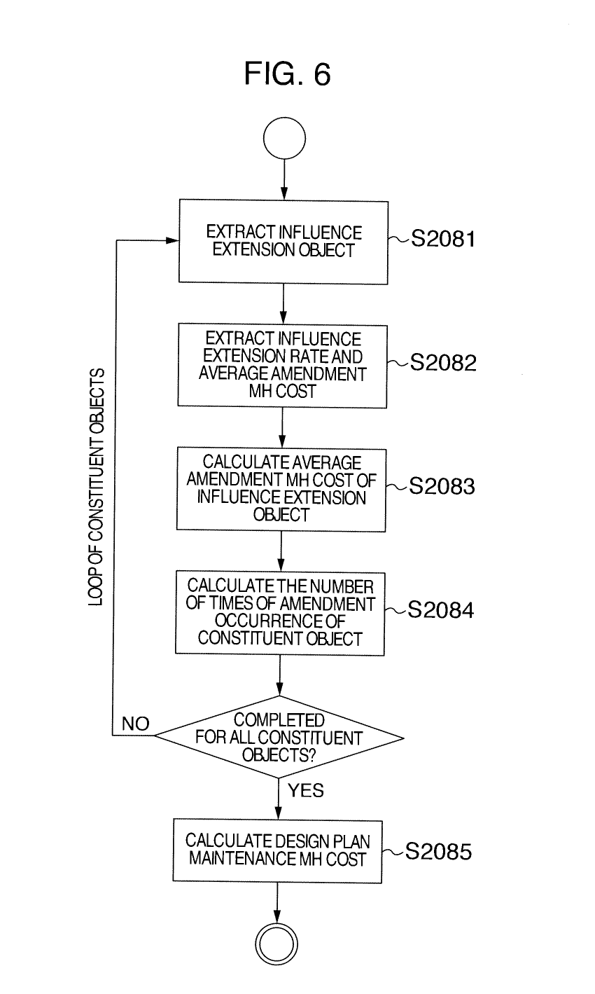

Details of the processing S208 are represented by processing S2081 to processing S2085 in a flow diagram shown in FIG. 6.

The processing S208 will now be described with reference to FIG. 6. FIG. 6 is a flow diagram showing a flow of processing for evaluating a maintenance man-hour cost every design plan of the component on the basis of the component information.

The influence extension predictor 241 in the component design supporting system 2 extracts a combination of a constituent object and a dependency object and a classification of a person in charge every component design plan of the component information in order of ascending constituent ID, and stores the dependency object into the influence extension prediction information storage 244 as an influence extension object (processing S2081). For example, as for a constituent ID “(1)-1” in the component information, the influence extension predictor 241 extracts a constituent object “vehicle insurance amount check function,” an influence extension object “→first order: vehicle insurance amount data,” and a classification of person in charge “within person in charge” the influence extension prediction information, on the basis of a combination of a constituent object “vehicle insurance amount check function” and a dependency object “vehicle insurance amount data”. On the basis of a combination of a constituent object “vehicle insurance amount check function” and a dependency object “vehicle premium calculation function,” the influence extension predictor 241 extracts a constituent object “vehicle insurance amount check function,” an influence extension object “→first order: vehicle premium calculation function,” and a classification of person in charge “between persons in charge” in the influence extension prediction information. In addition, with respect to an influence extension object “→first order: vehicle premium calculation function,” the influence extension predictor 241 extracts a constituent object “vehicle premium calculation function” having the same name in the same component design plan and its dependency object “vehicle premium discount check function” as an influence extension object “→second order: vehicle premium discount check function” in order to extract second-order influence extension. As for third-order extension as well, similar processing is executed and it is repeated until the dependency object becomes “−” (runs out).

The influence extension predictor 241 in the component design supporting system 2 conducts matching with influence extension pattern names stored in the influence extension pattern information storage 225 every combination of a constituent object and an influence extension object stored in the influence extension prediction information storage 244, and extracts an influence extension rate and an influence extension average amendment man-hour cost in a coincident influence extension pattern name (processing S2082). For example, with respect to a combination of a constituent object “vehicle insurance amount check function” and an influence extension object “vehicle insurance amount data, the influence extension predictor 241 conducts matching with influence extension pattern names in the influence extension pattern information, and acquires an influence extension rate “7/11” and an influence extension pattern average amendment man-hour cost “within person in charge: 2 h/time, and between persons in charge: 4 h/time” in a coincident influence extension pattern name “vehicle insurance amount check function→vehicle insurance amount data.” In addition, if there is second-order extension in influence extension objects, the influence extension predictor 241 conducts matching with influence extension pattern names in the influence extension pattern information with respect to a combination of a first-order extension “vehicle premium calculation function” and a second-order extension “vehicle premium discount check function”, and acquires an influence extension rate “6/8” and an influence extension pattern average amendment man-hour cost “within person in charge: 1 h/time, and between persons in charge: 6 h/time” in a coincident influence extension pattern name “vehicle premium calculation function→vehicle premium discount check function.” As for third-order extension as well, similar processing is executed anti it is repeated until the dependency object becomes “−” (runs out).

Every constituent object stored in the influence extension prediction information storage 244, the influence extension predictor 241 in the component design supporting system 2 calculates an influence extension object average amendment man-hour cost on the basis of an influence extension rate, an influence extension pattern average amendment man-hour cost, and a classification of person in charge of an influence extension object, and stores the influence extension object average amendment man-hour cost into the influence extension prediction information storage 244 (processing S2083). For example, with respect to a constituent object “vehicle insurance amount check function,” on the basis of an influence extension rate “7/11,” an influence extension pattern average amendment man-hour cost “within person in charge: 2 h/time, and between persons in charge: 4 h/time,” and a classification of person in charge “within person in charge” for an influence extension object “vehicle insurance amount check function→first order: vehicle insurance amount data,” the influence extension predictor 241 multiplies the influence extension rate “7/11” by the influence extension pattern average amendment man-hour cost “within person in charge: 2 h/time” as represented by “(7/11)*2=14/11 h/time” (* is a multiplication operator) On the basis of an influence extension rate “8/11,” an influence extension pattern average amendment man-hour cost “within person in charge: 3 h/time, and between persons in charge: 7 h/time,” and a classification of person in charge “between persons in charge” for an influence extension object “vehicle insurance amount check function→first order: vehicle premium calculation function,” the influence extension predictor 241 multiplies the influence extension rate “8/11” by the influence extension pattern average amendment man-hour cost “between persons in charge: 7 h/time” as represented by “(8/11)*7=56/11 h/time.” On the basis of an influence extension rate “6/8,” an influence extension pattern average amendment man-hour cost “within person in charge: 1 h/time, and between persons in charge: 6 h/time,” and a classification of person in charge “within person in charge” for an influence extension object “first order: vehicle premium calculation function→second order: vehicle premium discount check function,” the influence extension predictor 241 multiplies the influence extension rate “6/8” by an influence extension rate “8/11” for “vehicle insurance amount check function→first order: vehicle premium calculation function” and an influence extension pattern average amendment man-hour cost “within person in charge: 1 h/time” as represented by “(6/8)*(8/11)*1=6/11 h/time.” On the basis of an influence extension rate “1/8,” an influence extension pattern average amendment man-hour cost “within person in charge: 1 h/time, and between persons in charge: 3 h/time,” and a classification of person in charge “within Person in charge” for an influence extension object “first order: vehicle premium calculation function→second order: vehicle premium discount data,” the influence extension predictor 241 multiplies the influence extension rate “1/8” by the influence extension rate “8/11” for “vehicle insurance amount check function→first order: vehicle premium calculation function” and an influence extension pattern average amendment man-hour cost “within person in charge: 1 h/time” as represented by “(1/8)*(8/11)*1=1/11 h/time.” The influence extension predictor 241 finds an influence extension object average amendment man-hour cost “7 h/time” by calculating a sum of them.

In the present embodiment, an example in which influence extension objects are extracted up to the third-order extension has been described. However, a case where influence extension including a fourth-order extension and so on is extracted and a case where a lower value of the influence extension rate is set previously and influence extension which is lower than the lower limit value is removed from the object are also conceivable.

Every component design plan stored in the influence extension prediction information storage 244, the maintenance man-hour cost calculator 242 in the component design supporting system 2 extracts a constituent object and an influence extension object average amendment man-hour cost, conducts matching between the extracted constituent object and amendment target pattern names stored in the amendment target pattern information storage 224, extracts an amendment target pattern average amendment man-hour cost and the number of times of amendment occurrence for a coincident amendment target pattern name, and stores them into the maintenance man-hour cost information storage 245 (processing S2084). For example, the maintenance man-hour cost calculator 242 extracts a constituent object “vehicle insurance amount check function” and an influence extension object average amendment man-hour cost “7 h/time” in the influence extension prediction information, conducts matching between the extracted constituent object “vehicle insurance amount check function” and amendment pattern names in the amendment target pattern information, extracts an amendment target pattern average amendment man-hour cost “2 h/time” and the number of times of amendment occurrence “5.5 times/year” for a coincident amendment target pattern name “vehicle insurance amount check function,” and stores them into the maintenance man-hour cost information storage 245.

The processing S2081 to the processing S2084 are executed for each of the constituent objects in the component information.

Every component design plan stored in the maintenance man-hour cost information storage 245, the maintenance man-hour cost calculator 242 in the component design supporting system 2 calculates a design plan maintenance man-hour cost on the basis of an amendment target object average amendment man-hour cost, an influence extension object average amendment man-hour cost, and the number of times of amendment occurrence for a It constituent object. and stores the design plan maintenance man-hour cost into the maintenance man-hour cost information storage 245 (processing S2085). For example, the maintenance man-hour cost calculator 242 conducts processing of adding up an amendment target object average amendment man-hour cost “2 h/time” and an influence extension object average amendment man-hour cost “7 h/time” for a constituent object “vehicle insurance amount check function” in a component design plan “design plan (1)” in the maintenance man-hour cost information, and multiplying a resultant sum “9 h/time” by the number of times of amendment occurrence “5.5 times/year, and executing such processing for each of constituent objects. The maintenance man-hour cost calculator 242 finds a design plan maintenance man-hour cost “174.5 h/year” by adding up resultant products.

The component constituent ID evaluator 243 in the component design supporting system 2 acquires component design plans, constituent object average amendment man-hour costs, the numbers of times of amendment occurrence, and design plan maintenance man-hour costs stored in the maintenance man-hour information storage 245, and transmits them to the component design information input/output system 3 as an evaluation result (processing S209).

The component information transceiver 301 in the component design information input/output system 3 displays the maintenance man-hour cost information received from the component design supporting system 2 on a screen as shown in FIG. 20 and presents it to the component designer (processing S302).

The screen shown in FIG. 12 displays the design plans (1) and (2) shown in FIG. 18.

Description of the present embodiment will be finished. This description is an example and it does not confine the present invention By the way, in the present embodiment. the target of evaluation is dependencies of functions and data. However, it is also possible to execute the evaluation by taking only dependencies among functions, only dependencies among data or dependencies among classes each obtained by uniting a function and data as a target. The present invention can be changed or improved without departing from the spirit thereof, and in addition, it is a matter course that the present invention incorporates its equivalents.

1. A component design supporting method for supporting a system designer in design of a component which is a unit of a subsystem obtained by putting a function and data of a business application together, the component design supporting method comprising the steps of:
acquiring maintenance history information or a component relating to the component to be designed;
generating maintenance pattern information including an amendment place, an amendment man-hour cost and an amendment influence extension place in maintenance and storing the maintenance pattern information into a storage device;
conducting comparison with the maintenance pattern information with respect to the component to be designed by the system designer; and
calculating a maintenance man-hour cost of the component to be designed, on the basis of a result of the comparison.

2. The component design supporting method according to claim 1, further comprising component information registration step of accepting design information of the component to be designed, from the system designer and storing the design information as component information, wherein
the comparison conducting step comprises comparing the stored component information with the maintenance pattern information, and
the maintenance man-hour cost calculating step comprises calculating the maintenance man-hour cost on the basis of a result of the comparison.

3. The component design supporting method according to claim 1, wherein the step of acquiring maintenance history information comprises acquiring the maintenance history information as maintenance history object information in which a system name of an amendment target place in the maintenance history information is converted to an object name on the basis of dictionary information for managing names of a function and data of the system.

4. The component design supporting method according to claim 1, wherein the maintenance pattern information is generated by extracting combinations of an amendment target place and an influence extension place influenced by an amendment from the maintenance history information as maintenance patterns, and calculating number of times of amendment occurrence, an amendment man-hour cost, and an influence extension rate every maintenance pattern.

5. The component design supporting method according to claim 4, wherein the component information registration step comprises accepting an ID of a person in charge of maintenance of a component, a constituent object which is a constituent element of the component, and a dependency object having a dependency to the constituent object, and registering component information comprising whether cooperation among a plurality of persons in charge of maintenance is generated with respect to a dependency object having a possibility of influence extension at time of maintenance of the constituent object.

6. A component design supporting system for supporting a system designer in design of a component which is a unit of a subsystem obtained by putting a function and data of a business application together, the component design supporting system comprising:
means for acquiring maintenance history information for a component relating to the component to be designed;
means for generating maintenance pattern information including an amendment place, an amendment man-hour cost and an amendment influence extension place in maintenance and storing the maintenance pattern information into a storage device;
means for conducting comparison with the maintenance pattern information with respect to the component to be designed by the system designer; and
means for calculating a maintenance man-hour cost of the component to be designed, on the basis of a result of the comparison.

7 . The component design supporting system according to claim 6, further comprising component information registration means for accepting design information of the component to be designed, from the system designer and storing the design information as component information, wherein
the comparison conducting means compares the stored component information with the maintenance pattern information, and
the maintenance man-hour cost calculating means calculates the maintenance man-hour cost on the basis of a result of the comparison.

8. The component design supporting system according to claim 6, wherein the means for acquiring maintenance history information acquires the maintenance history information as maintenance history object information in which a system name of an amendment target place in the maintenance history information is converted to an object name on the basis of dictionary information for managing names of a function and data of the system.

9. The component design supporting system according to claim 6, wherein the maintenance pattern information is generated by extracting combinations of an amendment target place and an influence extension place influenced by an amendment from the maintenance history information as maintenance patterns, and calculating number of tunes of amendment occurrence, an amendment man-hour cost, and an influence extension rate every maintenance pattern.

10. The component design supporting system according to claim 9, wherein the means for calculating a maintenance man-hour cost conducts matching between each combination of a constituent object and a dependency object in the component information and a maintenance pattern in the maintenance pattern information, calculates an influence extension rate and an amendment man-hour cost at time of maintenance of the constituent object, and calculates a maintenance man-hour cost of each component on the basis of the influence extension rate and the amendment man-hour cost at the time of maintenance of the constituent object.
